(19) United States
(12) Patent Application Publication
(10) Pub. No.: US 2006/0110579 A1
(43) Pub. Date: May 25, 2006

(54) Anti-Slip Device Having Stiff Fibers

(76) Inventor: Raoul East Drapeau, Vienna, VA (US)

Correspondence Address: RAOUL E DRAPEAU, 2410 LUCKETT AVENUE, VIENNA, VA, 22180, US

(21) Appl. No.: 10/906,158

(22) Filed: Feb. 4, 2005

Related U.S. Application Data
(60) Provisional application No. 60/630,675, filed on Nov. 24, 2004.

(51) Int. Cl. B32B 3/00

(52) U.S. Cl. 428/156

(57) ABSTRACT

A base material having a profusion of closely- and evenly-spaced, short, straight, thin and stiff fibers arising from its surface, where the fibers prevent the base material and another object to which it may be permanently attached, from slipping laterally relative to a second object, indentations on whose surface are engaged by the fibers on the material. Because the fibers are straight, they provide a robust anti-slip function parallel to the two surfaces, but are easy to remove in the direction perpendicular to the two surfaces.

### FIELD OF THE INVENTION

This invention relates to anti-slip devices attached to one surface and intended to prevent that surface from slipping or moving tangentially relative to another surface.

### DESCRIPTION OF RELATED ART

Typical anti-slip devices are composed of a fabric or other material whose surface is covered with a high-friction material such as soft rubber, abrasive grit or the like. Products having this construction are commonly available in floor mats, shoe soles (Harrison U.S. Pat. No. 6,055,748), clothes hangars (Ozaki U.S. Pat. No. 5,277,345), shoulder pads (Stegmeyer U.S. Pat. No. 6,179,178), stair treads and so forth. While effective in most cases where a force normal to both surfaces exists to maintain the friction, there are applications where these approaches are not the best solution. For example, neither solution works well to keep one fabric from slipping relative to another, such as one rug lying on top of another or a leather strap pressing against a fabric. In addition, the grit surface can become worn or clogged with dirt, and the rubber surface can lose its friction capability.

One invention similar to the current invention is described by Yabu (U.S. Pat. No. 4,507,343), except that its anti-slip fibers are at a 45 degree angle to the base fabric and face in alternate directions, whereas in the current invention, the fibers are either perpendicular to the base fabric, or at a single angle to it with all fibers facing in the same direction. This requirement places Yabu's invention at a distinct disadvantage when it is desired to engage a fabric, since the cross-angled fibers prevent easy engagement and disengagement, an important characteristic of the current invention.

Another invention similar in first appearance to the current invention is Taber (U.S. Pat. No. 3,932,950). In it, a shoe sole is covered with a profusion of rubber cylinders. However, these cylinders are much larger in diameter and length than those of the current invention, and are flexible, where stiffness of the anti-slip fibers and their small size is an important distinguishing characteristic in this disclosure.

The well-known Velcro-type hook and loop system (Mestral, U.S. Pat. No. 2,717,437) is very good at fastening two surfaces, including providing an anti-slip function. However, it is not at all appropriate when the two surfaces must not slip relative to each other, yet must also disengage easily, as is contemplated in the current invention.

There is no commercially-available product providing this function in the form described.

### BRIEF SUMMARY OF THE INVENTION

The current invention provides an effective solution in cases that require an anti-slip function between two fabrics, or between one object and either a slippery or rough material or similar object. It overcomes the deficiencies of existing anti-slip systems by providing, in a first illustrative embodiment, a strip with short, stiff fibers protruding from its surface. The substrate of the strip may be made of flexible woven, non-woven or molded fabric. This strip, which may be of any convenient geometric shape or size suitable to the application, is permanently attached to one object, so that its stiff fibers temporarily engage the surface of a second object when they are pressed together. This design provides a high friction parallel to the two surfaces as the short fibers of the strip engage those of the second object. Yet, both surfaces can be easily separated when desired, by simply pulling them apart.

### BRIEF DESCRIPTION OF THE SEVERAL VIEWS OF THE DRAWINGS

FIG. 1 shows a cross-sectional view of a portion of the two halves of a prior art hook and loop fastener system prior to engagement.

FIG. 2 shows a cross-sectional view of a portion of the two halves of a prior art hook and loop fastener fully engaged.

FIG. 3 shows a cross-sectional view of a portion of an anti-slip device adjacent to a fabric having looped fibers, according to a first embodiment of the invention.

FIG. 4 shows a cross-sectional view of a portion of the anti-slip device of FIG. 3 fully engaged with a fabric having looped fibers.

FIG. 5 shows a cross-sectional view of a portion of an anti-slip device adjacent to a woven fabric, according to a further embodiment of the invention.

FIG. 6 shows a cross-sectional view of a portion of the anti-slip device of FIG. 5 fully engaged with a woven fabric.

FIG. 7 shows a cross-sectional view of a portion of an anti-slip device adjacent to a deformable surface, according to a further embodiment of the invention.

FIG. 8 shows a cross-sectional view of a portion of the anti-slip device of FIG. 7 fully engaged with a deformable surface.

FIG. 9 shows a cross-sectional view of a portion of an anti-slip device adjacent an irregular surface, according to yet another alternative embodiment.

FIG. 10 shows a cross-sectional view of the device of FIG. 9 with the shafts engaged with the irregular surface.

FIG. 11 shows a cross-sectional view of a portion of another alternative embodiment with shafts emerging from the substrate at a non-perpendicular angle and adjacent to a fabric having looped fibers.

FIG. 12 shows a cross-sectional view of the device of FIG. 11 with shafts emerging from the substrate at a non-perpendicular angle and fully engaged with a fabric having looped fibers.

FIG. 13 shows a top view of an anti-slip device sewn to an underlying object.

FIG. 14 shows a top view of an anti-slip device attached to an underlying object by an adhesive layer.

FIG. 15 shows an oblique view of an anti-slip device sewn to an underlying object.

### DETAILED DESCRIPTION OF THE INVENTION

There are many applications where it is desirable to press two surfaces together, and have them be difficult to move relative to each other in a direction parallel to their surfaces, yet be easy to separate in a direction normal (i.e. perpendicular) to that surface. One of the devices that comes to mind in such a situation is a Velcro-type hook and loop fastener (Mestral, U.S. Pat. No. 2,717,437). However, while hook and loop provides a robust friction parallel to the two component surfaces, it also provides a very strong connection preventing separation—indeed, that is one of its primary design features. As such, in the kind of application described here, it is not suitable. On the other hand, hook and loop does provide an instructive example of how the current invention is constructed.

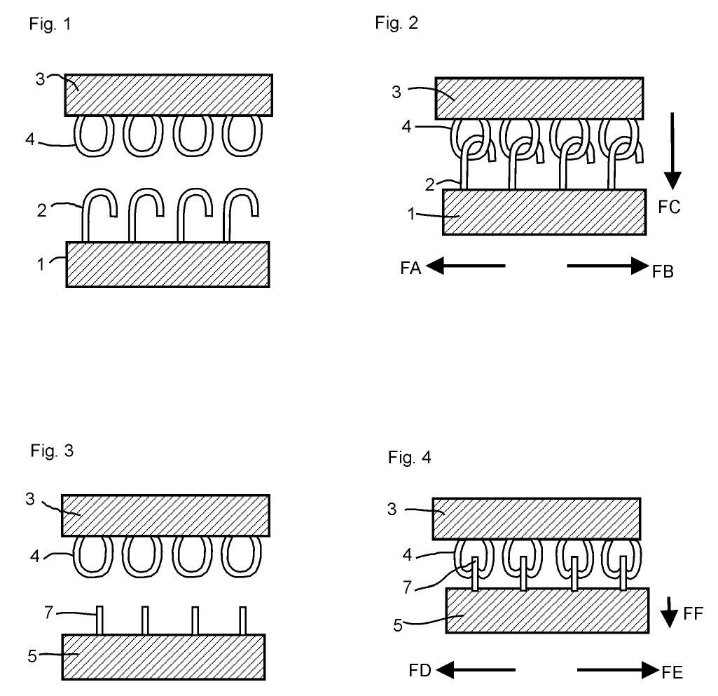

Consider FIG. 1, which shows a simplified cross-sectional view of a portion (for example, one row) of a hook and loop fastener pair with hooks 2, loops 4, and substrate fabrics 1 and 3, not yet brought together. Then, FIG. 2 shows a simplified cross-sectional view of a portion of the same two halves in contact. The hooks 2 engage the loops 4 and the result is a robust connection, requiring considerable force FC to peel the two apart and also a similarly large force FA or FB to separate them in a direction parallel to their surfaces (forces normal to the plane of the paper are not indicated, but would be similar in magnitude).

NOTE: In this drawing and the others to follow, where forces are indicated, assume that the second object (the upper member of the pair) (e.g. 3) is held stationary, and the separation or motion of the anti-slip (e.g. 1), is attempted relative to the second object.

FIG. 3 shows a simplified cross-sectional view of a portion of the current invention, which has upward facing, straight fibers, or shafts 7, of a similar length, diameter and material to those used in hook and loop, but without the hook. These shafts emerge from a substrate 5, adjacent to a fabric object 3, having loops, 4. This object can be either the same kind of fabric used in hook and loop systems, or any other kind of fabric having loops or a sufficiently loose weave whose gaps produce a surface with which the shafts can engage and produce a useful force in the direction parallel to the surfaces. FIG. 4 shows a simplified cross-sectional view of a portion of the same two surfaces brought together, with shafts 7 penetrating the fabric sufficiently far to engage its loops, 4. In this case, any attempt to move the two surfaces in a direction parallel to their surfaces will cause the shafts to press against the looped fibers of the fabric 3 and restrict such motion due to the inherent stiffness of the shafts. This force is indicated by the vectors FD and FE (again, forces in the direction normal to the plane of the paper are not shown, but are similar in magnitude). Fibers 4 are shown somewhat deformed by the application of the force FD or FE. The restrictive force will be fully realized when there is a force normal to the two surfaces pressing them together (not shown). Note that even though the two surfaces will be difficult to move parallel to their surfaces, whenever desired they will be easy to separate by pulling them apart perpendicular to the surface or by peeling them apart, both as indicated by the much smaller force vector FF. This feature is one of the most important aspects of the current invention; the presence of a large force restricting relative motion in a direction parallel to the surfaces of the current invention and the object with which it is engaged, yet retaining the ability to easily separate them in the normal direction.

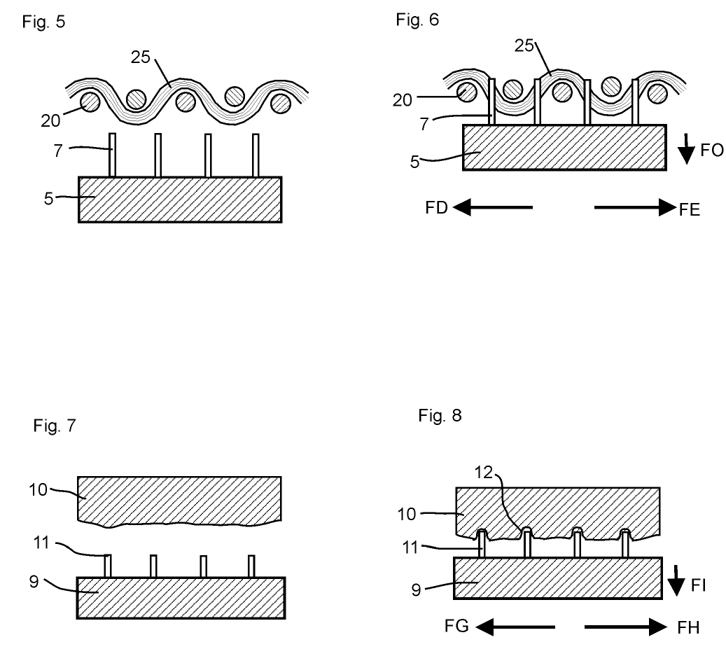

The previous figures and discussion describe applications involving using the current invention to engage fabrics of the kind seen in hook and loop systems; that is, a base fabric that contains loops rising from the base. However, the current invention can also be used to effect in applications where the object being engaged is a woven fabric whose weave is loose and or soft enough to allow the shafts to engage it. FIG. 5 shows both warp and woof thread directions 20 and 25 of such a fabric. The shafts typically would penetrate the gap between the warp and woof threads. The shafts 7, of the current invention, are poised adjacent to the fabric prior to engagement. FIG. 6 shows the shafts 7 of the current invention fully engaged with the fibers 20 and 25 of the fabric, resulting in large restraining forces FD or FE and a much smaller separating force FO.

While the fabric shown in FIG. 5 is regular in its weave, as is the case for many fabrics, the current invention can also perform perfectly satisfactorily when engaged with more irregularly woven, or randomly-laid, non-woven fabrics.

While many applications exist involving fabrics as the second surface for which this strip is ideal for creating an anti-slip condition, there is also a different class of applications where exactly the same invention can be used. Soft surfaces, such as animal flesh, can be difficult to handle because of their slipperiness. In that case, as shown in FIG. 7, a cross-sectional view of a portion of the current invention where somewhat shorter (and hence stiffer) shafts 11 rising from substrate 9 are placed adjacent to a soft and relatively smooth second surface 10. FIG. 8 shows the two halves after engagement where the shafts 11 are pressed into the resilient surface 10, creating dimples 12. It is the vertical surfaces of these dimples in combination with an external normal force (not shown), that interact with the shafts 11 and produce the retraining forces FG or FH against parallel motion. As is the case in FIG. 4 or FIG. 6, the separation of the two halves can be accomplished easily, as indicated by the small force vector FI.

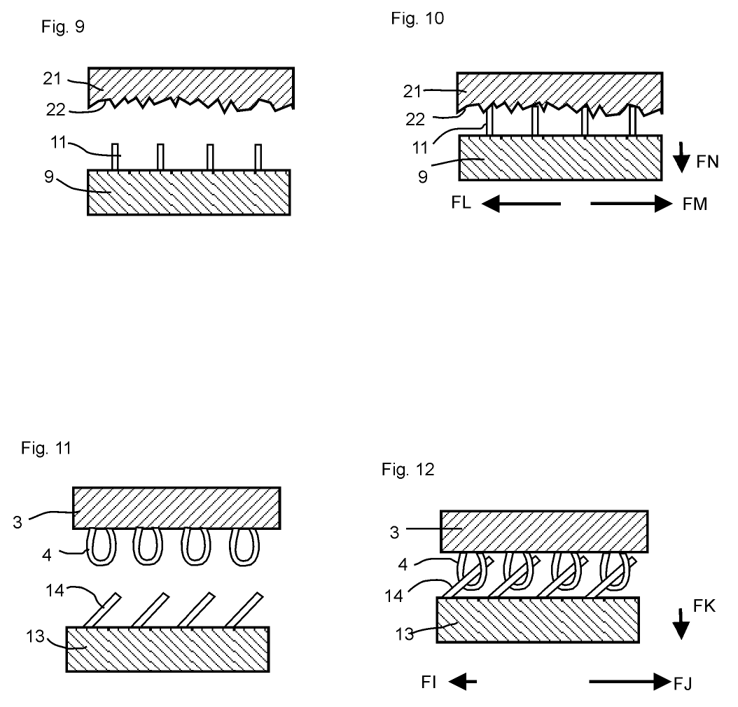

Yet another application where the same current invention can be usefully employed, is where the second surface is hard, but irregularly roughened, such as an abrasive material. This situation is shown in FIG. 9, where the shafts 11 of the current invention are shown adjacent to such a irregular surface 22 of an object 21. FIG. 10 shows the current invention fully engaged with the rough surface. As with all the other variations, a force normal to both surfaces (not shown) is necessary to achieve the full restraining force, shown here as FL and FM. The separating force, FN, is small, as in the other variations.

FIGS. 3-10 show shafts that are perpendicular to the substrate. This configuration produces a product whose restraining force parallel to the surfaces is the same in all directions. However, there are situations (such as mounting the strip in the palm of a glove for certain operations) where it may be desirable to have an asymmetric restraining force that is greater in one direction than another. In that case, a configuration such as that shown in FIG. 11 is useful and is a simple variant of the current invention. Here, shafts 14 emerge out of a substrate 13 at a non-perpendicular angle with all fibers facing in the same direction. When the surfaces are brought together as shown in FIG. 12 they can engage the loops 4 of substrate 3. In this case, the force FJ in one direction can be much greater than the one in the opposite direction, FI, thus creating the desired asymmetric effect. The separation force FK remains small.

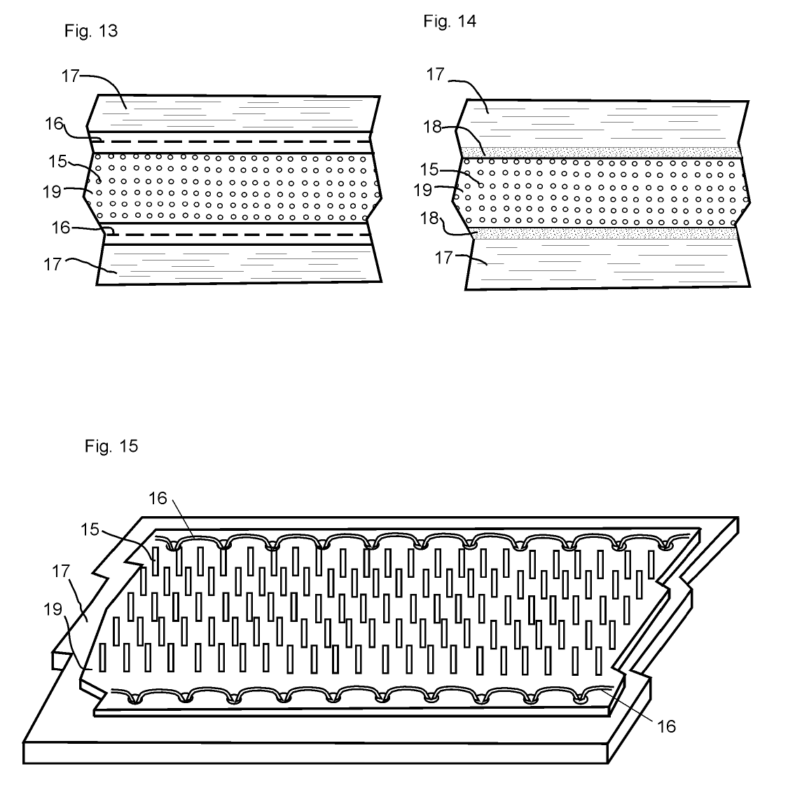

In most applications, the described strip will be attached permanently to an object. In this case, the current invention could be manufactured in the form of a rectangular strip and attached to an existing product such as a handbag strap by sewing, ultrasonic welding, adhesive or similar method. FIG. 13 shows a top view of the strip 19 sewn with stitches 16 to an object 17 along the outer edge of the strip that is free of shafts, whereas FIG. 14 shows a top view of the strip 19 attached to a rigid object 17 by an adhesive layer 18, whose edge is indicated.

FIG. 15 shows an oblique view of the objects depicted in FIG. 13. The substrate of the current invention 19, carrying shafts 15 is sewn by stitches 16 to object 17. As previously mentioned, substrate 19 could also be attached to the object 17 by other means such as adhesive bonding or ultrasonic welding.

The construction of the anti-slip strip can be a base fabric with woven-in plastic shafts, similar to the manufacturing process used in hook and loop systems, or it can be a molded product where the shafts are an integral part of the substrate. The drawings of FIGS. 3-12 apply in any of these cases. The manufacturing process for creating shafts of the kind described is well known in the hook and loop business. In this case, both shafts of a loop would be cut or sheared to create an adjacent identical pair, rather than just one of them below the top to create the usual hook. This invention then, provides a way for suppliers of hook & loop fastener systems to expand their product lines with minimum change to their manufacturing processes.

The specific length, diameter, rigidity and angle of the shafts extending from the substrate will depend on the application. If the anti-slip strip is to be used to engage a woven fabric with a looped pile for example, then the distance between adjacent shafts should ideally be the same or even greater than the distance between adjacent loops or threads in the fabric, as shown in FIG. 3. The ideal ratio between shaft length and its diameter will depend on the inherent stiffness of the material from which the shaft is constructed, but a ratio of about 5:1 or less is likely to provide sufficient stiffness to retard slippage. The length of the shafts will also depend on the application, but to properly engage most fabrics, they will be 1-2 millimeters long.

The material from which the shafts are made can be the same as that of the base fabric, such as nylon, or can be any other material compatible with the manufacturing process and providing the necessary physical characteristics. These materials could include plastics, metal or glass fibers which may also be stiffened by the application of a thermoset resin.

Of course, one skilled in the art will appreciate how a variety of alternatives are possible for the individual elements, and their arrangement, described above, while still falling within the scope of the invention. The above description has been presented for purposes of illustration and description of an embodiment of the invention, but is not intended to be exhaustive or limited to the form disclosed. This embodiment was chosen and described in order to explain the principles of the invention, show its practical application, and to enable those of ordinary skill in the art to understand how to make and use the invention. Many modifications and variations will be apparent to those of ordinary skill in the art. Thus, it should be understood that the invention is not limited to the embodiments described above, but should be interpreted within the full spirit and scope of the appended claims.

1. An anti-slip device for inhibiting lateral slippage between a first object coupled with the device and an indented or conformable face of a second object, said anti-slip device comprising:
a base material having a first outwardly facing surface, and plural spaced-apart stiff fibers extending outwardly from the surface in substantially the same direction, each fiber having a side extending outwardly to a distal end, the fibers having a predetermined dimension to fit, when the face and fibers are engaged, between protruding elements formed in said face, whereby fibers forcefully engage opposing protruding elements so as to substantially inhibit lateral slippage between the first and second objects in at least a first lateral direction without substantially inhibiting separation of the engaged first and second objects.

2. The device of claim 1, wherein the protruding elements conform with indentations on the face having irregular peaks extending from the face and the fibers each have a predetermined width and separation sized to fit within indentations between peaks of the face, whereby substantially all of the fibers extending from a first portion of the outwardly facing surface engage opposing indentations when the device and face are brought in contact with each other so as to resist any lateral movement of the face relative to the first object.

3. The device of claim 2, wherein the base material is flexible to accommodate flexure of the first object, and the first portion has a predetermined density of fibers so that when the base material is flexed and only the first portion is in contact with the face, the force exerted through the fibers of the first portion against the indentations of the face substantially inhibits lateral slippage.

4. The device of claim 1, wherein the face is conformable with the protruding elements formed when the fibers engage the face, the protruding elements defining indentations, and the fibers have a predetermined width and spacing whereby complimentary indentations are formed in the face for substantially all fibers engaging the face.

5. The device of claim 1, further comprising a coupler from at least one member of the group of an adhesive attached to an inward surface facing the first object for adhering the base material to the first object, a thread sewn through the base material into the first object, and plural welds for joining portions of the base material to the first object.

6. The device of claim 1, wherein the protruding elements comprise at least one member of the group of hooks, loops, ridges, spaced-apart threads, woven fabrics, non-woven fabrics, and non-indented resilient skin, and wherein the fibers are at a substantially uniform angle to the first surface at a predetermined width and spacing so substantially each of the fibers engage an inwardly extending side of an opposing one of the protruding elements so as to inhibit lateral slippage.

7. The device of claim 1, wherein the fibers have a uniform length between 1 and 2 millimeters, and a width no less than 20% of the length.

8. The device of claim 1, wherein the fibers form a substantially uniform acute angle to the first surface, whereby slippage is prevented upon application of a first amount of lateral force in the direction the fibers extend from the first surface but slippage will occur upon application of the same amount of force in the opposite direction.

9. An apparatus which resists slippage when pressed against the face of a second object, the face having indentations, the apparatus comprising:
a first device,
an anti-slip strip comprising a base material and plural spaced-apart stiff fibers extending outwardly in approximately the same direction from a first surface of the base material, the fibers shaped to fit between protrusions formed in said face when the apparatus is pressed against the face, whereby the fibers, when forced into contact with walls of opposing protrusions as the apparatus is pressed against the second object, inhibit lateral slippage between the apparatus and the face in at least a first lateral direction without substantially inhibiting separation of the apparatus and object when no longer pressed together; and
a connector operably attaching a second surface of the base material to the first device.

10. The apparatus of claim 9, wherein the fibers form a substantially uniform acute angle to the first surface, whereby slippage is prevented upon application of a first amount of lateral force only in approximately the direction the fibers extend from the first surface and is not prevented upon application of the same amount of force in the opposite direction.

11. The apparatus of claim 9, wherein the fibers form a substantially uniform perpendicular angle to the first surface, whereby lateral slippage is substantially prevented in all directions.

12. The apparatus of claim 9, wherein the base material is at least one member of the group of a woven fabric, a non-woven fabric, a molded material, and a synthetic fabric; the fibers are at least one member of the group of a natural, glass, non-magnetic metal, and plastic fiber, being one of the group of fibers naturally stiff when formed and fibers stiffened by application of a further material; the connector is at least one member of the group of an adhesive and a thread; and the first device is at least one member of the group of a fabric, clothing, leather product, and metallic object.

13. A coupled yet readily disengaged set of apparatuses, comprising
a first apparatus comprising an inward face having indentations:
a second apparatus,
an anti-slip device comprising a base material and plural spaced-apart stiff fibers extending outwardly in approximately the same direction from a first surface of the base material;
and a connector attaching a second surface of the base material to the second apparatus;
wherein the fibers have predetermined dimensions to fit within the indentations formed in said face when the second apparatus is forced against the face, whereby the fibers, when forced into contact with walls of opposing indentations as the apparatuses are pressed together, inhibit lateral slippage between the apparatuses in at least a first lateral direction without substantially inhibiting separation of the apparatuses when no longer pressed together.

14. The set of apparatuses of claim 13, wherein the fibers form a substantially uniform acute angle to the first surface, whereby slippage is prevented upon application of a first amount of lateral force only in approximately the direction the fibers extend from the first surface and is not prevented upon application of the same amount of force in the opposite direction.

15. The set of apparatuses of claim 13, wherein the fibers form a substantially uniform perpendicular angle to the first surface, whereby lateral slippage is substantially prevented in all directions.

16. The set of apparatuses of claim 15, wherein the base material is at least one member of the group of a woven fabric, a non-woven fabric, a molded material, and a synthetic fabric; the fibers are at least one member of the group of a natural, glass, non-magnetic metal, and plastic fiber, being one of the group of naturally stiff when formed and stiffened by application of a further material; the connector is at least one member of the group of an adhesive and a thread; and the first apparatus is at least one member of the group of a fabric, clothing, leather product, and metallic object.

17. A method for forming a coupled set of readily disengaged objects having differing opposing surfaces, comprising:
a) attaching an anti-slip strip to a first object, the strip comprising a base material and plural spaced-apart stiff fibers extending outwardly in approximately the same direction from a first surface of the base material;
b) forcing the first object against a second object so that the fibers are forced into indentations of a face of the second object, wherein the fibers have a predetermined width less than an average indentation width, whereby the fibers, when forced into contact with walls of opposing indentations inhibit lateral slippage between the objects without substantially inhibiting separation of the objects when no longer pressed together.

18. The method of claim 17, wherein step a) comprises one of the group of adhering, sewing, and welding the anti-slip strip to the first object.

19. The method of claim 18, wherein the step of forcing comprises at least one of the group of placing one of the objects such that its weight is pressed against the other of the objects, and applying an external force to hold the objects together.

20. The method of claim 17, in which the objects are temporarily coupled when forced together, but when not forced together will slip laterally relative to each other upon the application of a predetermined threshold level of lateral force.
